(19) United States
(12) Patent Application Publication
(10) Pub. No.: US 2003/0034374 A1
(43) Pub. Date: Feb. 20, 2003

(54) Tensioning device and component feed module having a tensioning device for pulling off cover films

(76) Inventors: Herbert Wallner, Schoenaich (DE); Alexander Worzischek, Neuried (DE)

Correspondence Address: HARNESS, DICKEY & PIERCE, P.L.C., P.O.BOX 8910, RESTON, VA, 20195, US

(21) Appl. No.: 10/197,842

(22) Filed: Jul. 19, 2002

(30) Foreign Application Priority Data
Jul. 19, 2001 (DE) 10135289.1

(51) Int. Cl. B32B 1/00; B65H 26/00

(52) U.S. Cl. 226/44; 156/584; 242/128

(57) ABSTRACT

A tensioning device used in pulling off cover films, and a component feed module including the tensioning device, includes a force sensor for measuring a pull-off force applied to the cover film. The force sensor is coupled to a control device, by which the film drive can be controlled to control the pull-off force of the cover film in such a way that the pull-off force is kept substantially constant.

The present application hereby claims priority under 35 U.S.C. §119 on German patent publication number 10135289.1 filed Jul. 19, 2001, the entire contents of which are hereby incorporated by reference.

1. Field of the Invention

The invention generally relates to a tensioning device for pulling cover films off component belts. Preferably, it relates to a device through which, the cover film pulled off by film drive, is guided.

2. Background of the Invention

Conventional tensioning devices, such as those according to EP 967850A1, have a supporting lever which is pre-stressed via a spring, and on which a projection is formed. The cover film pulled off component belts runs over a roller fitted to the supporting lever. The cover film running on the roller is tensioned by the spring. If there is a minimum tension on the cover film, then the projection of the supporting lever is located outside the measurement path of a light barrier. If the tension of the cover film decreases, then the supporting lever and therefore the projection on the measurement path is moved toward the light barrier by the spring and interrupts the measurement path, so that by the light barrier it is possible to assess that the tension is too low.

However, in the case of the known tensioning device for cover films, the tension of the cover film is subject to wide fluctuations. Since the spring used as a pre-stressing device exerts a force on the cover film that depends on the spring travel and extremely different spring travels occur in the form of angular positions of the supporting lever, the force with which the cover film is tensioned varies to an undesirably great extent.

### SUMMARY OF THE INVENTION

It is an object of an embodiment of the invention to specify a tensioning device for cover films by which the force exerted on the cover film can be kept approximately constant.

An object can be achieved by the tensioning device according to an embodiment of the invention having the features as claimed in claim 1. Preferred refinements of the invention are claimed in the dependent claims.

According to an embodiment of the invention, a tensioning device for pulling cover films off component belts is provided. There, the cover film has already been pulled off the component belt via a film drive. For the purpose of controlled pulling, the cover film is led along on a tensioning device, by which it can be tensioned continuously at an angle to the pull-off direction. According to an embodiment of the invention, a force sensor is provided to measure the pull-off force which is applied to the cover film. A control device can be coupled to the force sensor and to the foil drive to control the pull-off force. This makes continuous registration of the pull-off force possible. By feeding this pull-off force back into a control device, by which the foil drive can also be controlled, it is possible to keep the pull-off force with which the cover film is pulled off constant within very close limits.

The force sensor can be an analog position sensor, for example, by which the position of the tensioning device relative to the cover film can be registered. In this way, a change in the travel or angle of the tensioning device relative to the cover film can be registered by the force sensor.

For example, the force sensor can be coupled to the control device via an analog/digital converter. This makes it possible to use digital signal processing in the control device, and therefore to apply digital control algorithms to keep the pull-off force of the cover film constant.

The position sensor can have a permanent magnet and a Hall sensor. The position of the tensioning device can therefore be determined from the measured Hall voltage. The measured Hall voltage is supplied to the control device in order, for example, to be used as a controlled variable.

According to an embodiment of the invention, a component feed module for automatic insertion machines can also be provided, which includes a tensioning device for pulling off the cover film. Using a feed module of this type, constant pull-off forces of the cover films from component belts can be possible. In this way, the speed at which the component belt is transported onward can in turn be increased. In this way, via the tensioning device according to an embodiment of the invention, higher insertion speeds in insertion systems for electronic components can be achieved.

### BRIEF DESCRIPTION OF THE DRAWINGS

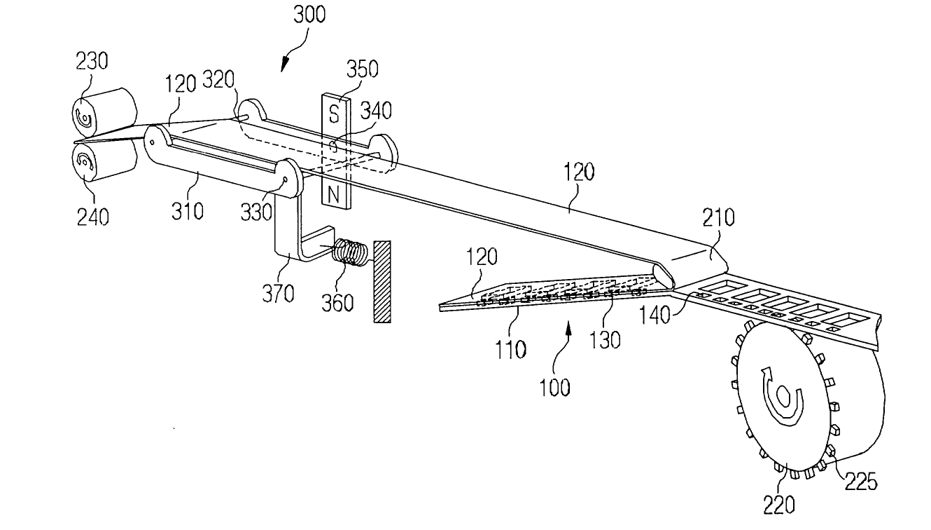

The invention will be explained in more detail with reference to the drawing. In the drawing, FIG. 1 shows a preferred embodiment of the tensioning device according to an embodiment of the invention.

### DETAILED DESCRIPTION OF THE PREFERRED EMBODIMENTS

FIG. 1 shows a tensioning device 300 according to an embodiment of the invention in a perspective schematic side view. The tensioning device 300 according to an embodiment of the invention includes a frame 310 which is mounted such that it can pivot on an axis 330. A tensioning roller 320 is provided at an end region of the frame 310 facing away from the axis 330. The frame 310 also has an extension 370 which extends radially from the axis 330. A compression spring 360, which is supported on a housing, not shown, acts on the extension 370. As a result, the tensioning device 330 according to an embodiment of the invention is pre-tensioned in the upward direction in a pivoting movement about the axis 330.

Fitted in the frame 310 is a Hall sensor 340, which interacts with a permanent magnet 350 arranged on the housing, not shown. In this case, while the frame 310 of the tensioning device 300 passes through its pivoting range around the axis 330 or a section of this pivoting range, by use of the Hall sensor 340 and the permanent magnet 350, Hall voltages corresponding to the respective position of the frame 310 relative to the housing can be tapped off on the Hall sensor 340.

A cover film 120 pulled off a component belt 100 can be pulled off the component belt 100, for example at a pull-off edge 210 of a component feed module (not shown) and, from the pull-off edge 210, can be guided over the tensioning roller 320 of the tensioning device 300 according to an embodiment of the invention to a pull-off device. Provided on the pull-off device are, for example, two rolls 230, 240 which rotate in opposite directions and between which the cover film 120 from the component belt 100 is clamped with a force fit and is pulled off in a pull-off direction A by the opposite rotation of the two rolls 230 and 240.

In addition, the component belt 100 has a base layer 110 with pockets 130, for example for components, and a perforation 140. At the perforation 140, the component belt 100 is gripped by a pin wheel 220 belonging to the component feed module and provided with pins 225 and is moved in a feed direction Z. Depending on the time at which a component is again to be removed from a pocket 130 in the component belt 100 by an insertion device, the component belt 100 is transported onward in the feed direction Z by a control device. During this transport, by use of a control device which is coupled to the drive of the pull-off device, that is to say the two rolls 230 and 240, and the output from the Hall sensor 340, the force with which the cover film 120 is pre-tensioned is kept constant.

For this purpose, for example a closed control loop is formed by the Hall sensor 340, the drive to the rolls 230 and 240 and the associated control device (not shown).

It is also possible to arrange the Hall sensor 340 to be stationary on the housing of the component feed module and for the permanent magnet 350 to be moveable on the frame 310 of the tensioning device 300. The permanent magnet 350 and the Hall sensor 340 can also be arranged on the extensioi 370 in the functioning manner described above. It is also possible to arrange a piezoelectric force sensor or the like at the bearing point of the spring 360 on the extension 370 or on the housing of the component feed module and to feed the output signal from said force sensor instead of the output signal from the Hall sensor 340 to the control device of the drive to the rolls 230 and 240.

An analog/digital converter can be provided on the control device, for example on the input side, by which converter the output signal from the Hall sensor 340 or the piezoelectric force sensor is converted into a digital signal and can be processed further by the control device by use of digital control algorithms.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A tensioning device used in pulling film off a belt, the film passing through the tensioning device, comprising:
a force sensor, provided to measure a pull-off force applied to the film;
a control device, coupled to the force sensor and coupled to a film drive for pulling off the film, to control the pull-off force.

2. The tensioning device as claimed in claim 1, wherein the force sensor is formed by the tensioning device and an analog position sensor, by which a position of the tensioning device relative to the film is registerable.

3. The tensioning device as claimed in claim 2, wherein the force sensor is coupled to the control device via an analog-to-digital converter.

4. The tensioning device as claimed in claim 2, wherein the position sensor includes a permanent magnet and a Hall sensor, and wherein the position of the tensioning device is determinable from a voltage by the Hall sensor.

5. The tensioning device as claimed in claim 1, wherein the force sensor, the control device and the film drive form a closed loop control.

6. A component feed module for automatic insertion machines, the feed module comprising:
a drive for component belts;
a pull-off edge, at which films of the component belts can be pulled off; and
a tensioning device as claimed in claim 1, used in pulling off the film.

7. The tensioning device of claim 1, wherein the film is tensioned continuously at an angle to a pull-off direction.

8. The tensioning device of claim 1, wherein the film is a cover film.

9. The tensioning device as claimed in claim 3, wherein the position sensor includes a permanent magnet and a Hall sensor, and wherein the position of the tensioning device is determinable from a voltage by the Hall sensor.

10. The tensioning device as claimed in claim 7, wherein the position sensor includes a permanent magnet and a Hall sensor, and wherein the position of the tensioning device is determinable from a voltage by the Hall sensor.

11. The tensioning device as claimed in claim 7, wherein the force sensor, the control device and the film drive form a closed loop control.

12. A component feed module for automatic insertion machines, the feed module comprising:
a drive for component belts;
a pull-off edge, at which films of the component belts can be pulled off; and
a tensioning device as claimed in claim 4, used in pulling off the film.

13. A component feed module for automatic insertion machines, the feed module comprising:
a drive for component belts;
a pull-off edge, at which films of the component belts can be pulled off; and
a tensioning device as claimed in claim 7, used in pulling off the film.

14. The tensioning device as claimed in claim 1, further comprising:
a frame, pivotable on an axis;
a tensioning roller, provided at an end region of the frame, wherein the frame includes an extension extending radially from the axis.

15. The tensioning device of claim 14, further comprising a compression spring, acting on the extension.

16. The tensioning device of claim 15, wherein the tensioning device is pre-tensioned in the upward direction in a pivoting movement about the axis.

17. The tensioning device as claimed in claim 7, further comprising:
a frame, pivotable on an axis;
a tensioning roller, provided at an end region of the frame, wherein the frame includes an extension extending radially from the axis.

18. The tensioning device of claim 17, further comprising a compression spring, acting on the extension.

19. The tensioning device of claim 18, wherein the tensioning device is pre-tensioned in the upward direction in a pivoting movement about the axis.

20. The tensioning device of claim 1, wherein the control device controls the pull-off force such that the pull-off force is kept substantially constant.
